(19) United States
(12) Patent Application Publication
(10) Pub. No.: US 2004/0063568 A1
(43) Pub. Date: Apr. 1, 2004

(54) Method for the production of form-selective catalysts and use thereof

(76) Inventors: Adolf Kuhnle, Marl (DE); Mark Duda, Ludwigshafen (DE); Karsten Seelbach, Engelskirchen (DE); Steffen Hasenzahl, Maintal (DE); Uwe Tanger, Bochum (DE); Carsten Jost, Marl (DE); Elias Klemm, Nurnberg (DE); Andreas Reitzmann, Karlsruhe (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/399,781

(22) PCT Filed: Oct. 12, 2001
(86) PCT No.: PCT/EP01/11806

(30) Foreign Application Priority Data
Oct. 26, 2000 (DE) 10053085.0
Aug. 9, 2001 (DE) 10139316.4

(51) Int. Cl. B01J 29/04; B01J 29/87

(52) U.S. Cl. 502/60

(57) ABSTRACT

The invention relates to a process for manufacturing zeolite catalysts containing subgroup metals by hydrothermal synthesis with subsequent calcination, which is characterized in that the subgroup metals are used in hydrothermal synthesis in the form of carbonyl, isonitrile or cyanocomplexes.

The catalysts thus produced can be used as a catalyst for removing nitrogen or for oxidizing organic compounds.

The present invention relates to a process for manufacturing form-selective catalysts on the basis of zeolites or mesoporous silicates by means of storing catalytically effective metal oxides as non-grid species in their channel and cavity structure, as well as the use of the catalysts thus produced.

In the past, zeblites have taken on more and more significance in the domain of catalyst research and in applied catalysis [Kerr, G. T. (1989): Spektrum der Wissenschaft 989 (9), 94].

Compared to other catalysts zeolites offer countless advantages:

They have a crystalline structure and accordingly a precisely defined configuration of SiO₄- and AlO₄ tetrahedrons. The result is good reproducibility in manufacture.

They have form selectivity, which means that only such-molecules can be converted as are smaller than the pore diameter of the zeolites.

Targeted installation of acid centers in the intracrystalline surface is possible directly with synthesis and/or by subsequent ion exchange.

Above 300° C. some zeolites have acid strengths in the mineral acid range.

Catalytically effective metal ions can be-applied to the surface evenly through ion exchange or impregnation or can be incorporated into the crystal framework. Ensuing reduction to pure metal is possible.

Zeolite catalysts are thermostable up to at least 600° C., in some cases to higher temperatures, and can be regenerated:by burning off carbon deposits.

Both zeolites and mesoporous silicates as well as their catalytic efficacy were described in detail by Sheldon et al. in Angew. Chem. 1997, 109, 1190-1211. So-called ‘ship in a bottle’ complexes or ‘zeozymes’ are also explained. These are inclusions of metal complexes in large pores, so-called supercages. Oxidation-stable ligands, such as phthalocyanine, polypyridine and aromatic Schiffs bases are employed as metal complexes. Normal procedure is such that the complex is composed in the pores of the supercage by diffusing in the ligands. These phthalocyanines, polypyridines or aromatic Schiffs bases have a catalytic effect, but are sensitive at higher temperatures. To obtain the catalytic effect they may not be destroyed, thermally for example.

Zeolite catalysts, containing metals and/or metal oxides in the crystal lattice, are known. U.S. Pat. Nos. 5,756,861 and 5,672,777 accordingly describe a ZSM-5 zeolite for oxidation of benzenes.

EP 0 889 018 likewise discloses a zeolite catalyst doped with Fe₂O₃. Minimal proportions of catalytically active iron additives in zeolites are described in U.S. Pat. No. 5,110,995.

During synthesis of the zeolites foreign metals are usually added in the form of soluble salts, such as nitrates, and incorporated by hydrothermal crystallization at high temperatures into the crystal compound of the Si/Al lattice. An Si atom is substituted here, giving rise to a Brønsted acid center.

In general, when metal ions are incorporated into the crystal lattice so-called Brønsted acid centers are created, whereas when metal oxides are deposited, in the channel structure of the zeolites for example, so-called Lewis acid centers are created.

This acidic character can be determined by way of TPDA analyses, that is, temperature-programmed desorption of ammonia. A representation of this methodology is found in Berndt et al., Microporous Materials, s (1994) 197-204, Elsevier Science B. V., Amsterdam.

Foreign metal atoms, which are incorporated into the crystal compound during synthesis of zeolites, can leave these lattice sites when the catalyst mass is being calcined and be deposited into the cavities of the zeolite structure. The resulting metal centers exhibit high catalytic activity, for example with oxidation of benzenes to phenol derivatives (Panov et al., Appl. Cat. A 141, 1996, 185-192 and Panov et al., Cat. Today 41, 1998, 365-385). This purely thermally induced exchange of foreign metals from lattice sites to metal centers deposited in cavities is thus a decisive step for the catalytic activity of the catalyst. Therefore, to improve the catalytic effect, as many metal centers as possible not localized to lattice sites of the zeolites should be created.

The object here was to develop a zeolite catalyst which is thermally stable, contains catalytically effective metals, metal complexes and/or metal oxides in the manner of a ‘ship in a bottle’ complex and which can be utilized for oxidation of organic substrates.

It was surprisingly found that the metals introduced by way of carbonyl cyano and/or isonitrile complexes can be incorporated into the channel and cavity structure of a zeolite, that on the one hand a catalytic effect is obtained, but on the other hand little or no Brønsted acidity is generated, for example through incorporation of metal ions into the lattice framework.

It was also surprising that this absence of Brønsted acidity caused a drastic decline in the inclination to coking and associated loss in activity. In addition, it was surprising that metals, metal complexes and/or metal oxides can be included in a zeolite, such that these materials do not bleed out.

And it was also surprising that a large quantity of metal ions in the channel structure and thus high catalytic activity was present immediately following synthesis. As already mentioned, metal ions must be stimulated to migrate from lattice sites into the cavities of the zeolites usually through the calcination process.

The object of the present invention is therefore a process for manufacturing zeolite catalysts containing subgroup metals by hydrothermal synthesis with subsequent calcination, which is characterized in that the subgroup metals in the form of complexes of the general formula

[metal_{z}(CO)ₐ(CN)_{b}(CNR)_{c}(X)_{d}(Y)ₑ]^{n- or n+}

with z≧1,

R=alkyl chain with 1 to 10 carbon atoms, a, b, c, d and e=0 or a whole number, whereby a, b, c, d and e can be identical or unidentical and the sum of a, b, c, d and e is ≧1,

n=0 or is a negative or positive whole number and

X and Y represent a volatile component are introduced in the hydrothermal synthesis of the zeolite catalysts.

It is also an object of the invention to use the zeolite catalysts manufactured according to the present invention in processes for oxidation of organic substrates (for example benzene to phenol or generally for hydroxylation of aromatic compounds), as a denitrification catalyst (for example in automobile exhaust gas catalysts and in power plants) and in fuel cells.

Synthesis according to the present invention of the zeolite catalysts containing subgroup metals is carried out similarly to a hydrothermal method known per se for manufacturing zeolites, as described for example in U.S. Pat. Nos. 4,410,501, 3,702,886, 5,055,623 or by lone et al. in Usp. Khimii, 56 (3) 1987, 393 ff.

The process according to the present invention for manufacturing zeolite catalysts containing subgroup metals by hydrothermal synthesis with subsequent calcination is distinguished in that the subgroup metals in the form of complexes of the general formula

[metal_{z}(CO)ₐ(CN)_{b}(CNR)_{c}(X)_{d}(Y)ₑ]^{n- or n+} (I)

with z≧1,

R=alkyl group with 1 to 10 carbon atoms, preferably a branched or unbranched alkyl

chain with 1 to 10, quite particularly preferably with 1 to 3 carbon atoms,

a, b, c, d and e=0 or a whole number, whereby a, b, c, d and e can be identical or unidentical and the sum of a, b, c, d and e is ≧1,

n=0 or is a negative or positive whole number and

X and Y represent a volatile component, such as for example water or ammonia are introduced in the hydrothermal synthesis of the zeolite catalysts. The subgroup metals can thus be introduced as pure carbonyl, cyano and/or isonitrile complexes, as mixed complexes or carbonyl, cyano or isonitrile complexes mixed with other volatile ligands in the hydrothermal synthesis of the zeolite catalysts. Examples of such complexes are NH₄[Fe(CO)₄(CN)], Fe(CO)₄(CNR), Fe(CNR)₄(CN)₂, where R can be an alkyl group, preferably a methyl or ethyl group.

The catalysts manufactured according to the present invention preferably exhibit pores having a diameter of less than 15 Angström, particularly preferably a pore diameter of 4 to 7 Angström. A preferable structural form is constituted by zeolites of type MFI or ZSM-5, MEL or ZSM-11, though also ferrierite and beta.

The subgroup metals are introduced to the catalyst in the form of the complexes according to the present invention in accordance with formula I, thus for example in the form of cyano complexes, isonitrile complexes and/or carbonyl complexes by means of so-called template synthesis. After calcination, which preferably occurs at temperatures above 500° C., finely distributed metal oxide remains in the channel or cavity structure of the zeolites. This metal oxide can de reduced to the elementary metal-by hydrogen as required. However, preferably the metal oxides resulting from the calcination process are used.

The complexes used according to the present invention in accordance with formula I should on the one hand be water-soluble, and on the other hand should remain stable in allmne medium. Therefore the subgroup metals are preferably introduced to the hydrothermal synthesis of the zeolite catalysts in the form of the carbonyl or cyano complexes stable in an alkaline environment.

With cyanocomplexes a cation removable by calcination is preferred, and in particular an ammonium compound (NH₄⁺) is used here. Basically, all types of subgroup metal cyanocomplexes are suitable, preferably those with 6 coordination points, for example having an octahedral structure, with 4 coordination points, for example having a planar or tetrahedral structure, particularly preferably those based on metals such as vanadium, chromium, molybdenum, tungsten, manganese, titanium, zirconium, hafnium, technetium, rhenium, iron, ruthenium, osmium, copper, cobalt, rhodium, nickel, iridium, palladium, platinum, galiurn, silver and/or gold, particularly preferable are ammoniumtetracyanonickelate, ammoniumtetracyanopalladate, ammoniumtetracyanoplatinate, ammoniumhexacyanoruthenate, ammoniumhexacyanoplatinate, ammoniumhexacyanocobaltate, ammoniumhexacyanochromate and ammoniumhexacyanoferrate. Likewise suitable are mixed complexes of these metals with the general structural formula [metal(CN)₅X]ⁿ⁻, whereby X represents a volatile component such as water or ammonia.

Amongst carbonyl compounds both mononuclear and polynuclear carbonyls of varying structure of the above-mentioned metals are suitable, in this case preferably iron pentacarbonyl. Likewise suitable are caibonyl metallic anions of the general structural formula NH₄[metal(CO)ⁿ⁻], in this case particularly ammoniumtetracarbonylferrate.

Isonitrile complexes can also be added pure or as mixed complexes of the metals claimed according to the present invention in accordance with formula I.

If iron is used as a catalytically active subgroup metal, according to the present invention it can be added to the reaction mixture for example as ammoniumhexacyanoferrate. Iron can be present in both divalent and/or trivalent form. It is also possible to add other stable complexes, such as iron carbonyls for example that are soluble in hot water or in alkaline medium, for example iron pentacarbonyl.

Certain metals, which are less capable of forming acid centers, such as for example Ti present in the 4th subgroup of the periodic table, can of course be incorporated without a problem. Conventional titanium silicalite, which for example according to U.S. Pat. No. 4,410,501 is manufactured from a hydrolysable titanium compound, such as TiCl₄, TiOCl₂, tetraalkoxytitanium, preferably tetraethoxytitanium, as well as from tetraethylorthosilicate and tetrapropylammoniumhydroxide, can thus be modified with amrnmoniumhexacyanoferrate or iron carbonyls according to the present invention, by means of which it is likewise well suited to the applications according to the present invention.

The acidity of the catalysts can be altered by way of the calcination process or by subsequent hydrothermal treatment with a gas containing water vapor at a temperature between 300 and 950° C., but also by incorporation of specific metals. With hydrothermal treatment with water vapor the zeolite catalyst is processed at a temperature of 300 to 950° C., preferably 450 to 800° C. with a gas containing from 1 to 100 mole percent, preferably from 10 to 100 mole percent and quite particularly from 50 to 99 mole percent water vapor. Examples of such suitable procedures are disclosed in WO 95/27560 (1995) or in DE 196 34 406 (1996). Such treatment can further raise the Lewis acidity.

With the use of trivalent metals such as aluminum, for example triisobutylaluminum, a required acid strength of the catalyst can be adjusted precisely. If little or almost no presence of acid centers, in particular of Brønsted acid centers, is required, as for example in oxidation reactions, it is recommended that the molar ratio of SiO₂:Al₂O₃ present after calcination is no more than 1:10⁻². The catalyst according to the present invention particularly preferably contains no aluminum.

Catalysts with a molar ratio of SiO₂to the subgroup metal of 1:10⁻⁵ to 1:3×10⁻² (relative to the calcinated catalyst) are preferably obtained by the process according to the present invention. It can be advantageous if the molar ratios are in narrower ranges, such as for example 1:10⁻⁴ to 1:5×10⁻² or 1:10⁻³ to 1:10⁻². These ratios apply for SiO₂ to the subgroup metal or subgroup metal oxide. In the case of iron as a subgroup metal the molar ratio of SiO₂ to Fe₂O₃ is preferably between 1:10⁻⁵ (minimum) to 1:1.5×10⁻² (maximum), preferably between 1:10⁻⁴ (minimum) to 1:10⁻² (maximum), particularly preferably between 1:0.6×10⁻³ (minimum) to 1:0.9×10⁻³ (maximum).

In particular a tetraalkylorthosilicate, such as for example tetraethylorthosilicate, any other silicate in colloidal form or a silicate of an alkali salt can be used as a silicon component in the process according to the present invention. The organic base can be a tetraalkylammoniumhydroxide, such as for example tetrapropylammoniumhydroxide.

The manufacturing method of the basic framework of the catalysts is described in U.S. Pat. No. 4,410,501.

According to the present invention, the transition metal can be added to the reaction mixture as ammoniumhexacyanometallate or ammoniumtetracyanometallate. It is also possible to add other stable complexes, for example carbonyls soluble in hot water or in alkaline medium.

Unsuitable for this are all compounds which do not represent stable complexes—in particular in alkaline medium—such as for example transition metal citrates and transition metal acetylacetonates, because they are incorporated solidly into the lattice framework and—in particular if they are not quadrivalent—create strong acid centers.

If a surplus of aminoniumhexacyano or ammoniumtetracyanometallates or metal carbonyls is used, these are also separated on the surface of the zeolites as oxides, apart from being deposited on non-lattice sites. This is generally not a disadvantage. In individual cases an additional catalytic effect can even arise as a result of this.

Of course catalysts manufactured according to the present invention can also be used in membranes with pore diameters of less than 2000 Angström. With pore diameters of 50 to 1000 Angström special ultrafiltration membranes are utilized. If the catalysts are used in the manufacture of nanofiltration membranes, the pore diameter fluctuates between 5 and 50 Angström. With a pore diameter of approx. 5 Angström these membranes are also suitable for gas separation. In particular they can also be used in batteries or fuel cells in connection with membrane applications. Use of the zeolite catalyst containing subgroup metals is therefore thoroughly possible in fuel cells.

The catalysts manufactured according to the present invention can be used in a broad range of applications in industrial chemistry, such as isomerization reactions, hydrogenation reactions, dehydrogenation reactions, alkylation reactions, disproportionation reactions, formation of alcohol from olefins, epoxidation, coupling reactions, substitution reactions, cycloaddition and cycloreversion reactions, formation of ether, crude oil cracking, hydrocracking, Fischer-Tropsch synthesis of alcohols or hydrocarbons, methanol synthesis from synthesis gas or methane, though in particular for oxidation reactions of organic substrates with atmospheric oxygen, hydrogen peroxide, organic peroxides or dinitrogen monoxide.

Use of the zeolite catalyst containing subgroup metals according to the present invention for oxidation of organic substrates is particularly preferred, in particular for manufacturing substituted and unsubstituted hydroxy aromatic compounds. The zeolite catalysts containing subgroup metals can be used in particular as a catalyst for manufacturing phenol from benzene, cresol from toluene, phenol substituted with several methyl groups from the corresponding benzene derivative, trimethylphenol and trimethylhydroquinone from trimethylbenzene, nitrophenol from nitrobenzene, phenol substituted with halogen from benzene substituted with halogen or aminophenol from aminobenzene.

Likewise the zeolite catalysts according to the present invention can be used as catalysts in the manufacture of multiple hydroxylated substituted and unsubstituted benzenes such as pyrocatechines, hydroquinones, pyrogallol and phloroglucine. Furthermore, with use of the zeolite catalysts according to the present invention multiple alkylsubstituted benzenes are hydroxylated. In this way trimethylbenzene for example can be oxidized to trimethylphenol or trimethylhydroquinone. In this way also tocopherols can be manufactured by use of the zeolite catalyst containing subgroup metals. This is an example of a route for synthesizing, α-tocopherol (Vitamin E), with the result that the catalyst according to the present invention can be utilized as a catalyst in the production of α-tocopherol.

The production of propylene oxide, based on propene and hydrogen peroxide or dinitrogen monoxide is also preferred. This may occur in both the liquid phase and the gas phase. The zeolite catalyst according to the present invention can also be used for this process.

A further option for using the catalysts manufactured according to the present invention comprises a denitrification catalyst in power plants and in waste gas facilities of internal combustion engines, such as for example in vehicles or nitric acid plants for removing unwanted nitrogen oxides (NOₓ).

These catalysts can also be used in fuel cells, in particular for coating the electrodes. In the latter case ammonium-hexacyanoplatinate can be used which can be reduced to atomic, finely distributed platinum after being deposited as oxide in the channel and cavity structure of a zeolite with hydrogen, for example.

Based on the example of oxidation of benzene to phenol on a catalyst manufactured according to the present invention, form selectivity and activity of the catalyst were examined on the one hand, and on the other hand a test was made via the use of dinitrogen monoxide as oxidation media as to how nitrogen oxides behave in this case.

Surprisingly, the synthesis of phenol from benzene was possible with a form-selective catalyst manufactured according to the present invention with high selectivity. The activity of the catalyst remained intact over the entire testing period. The dinitrogen monoxide was decomposed in pure nitrogen and oxidatively effective oxygen.

Use of the catalysts manufactured according to the present invention in processes for oxidizing organic substrates, for example of benzene or benzene derivatives, can be carried out, in which case a catalytic oxidation of the substrate with a gas containing dinitrogen monoxide at temperatures between 100-800° C., preferably 300-500° C. is carried out. The process is particularly suitable for the manufacture of phenol from benzene.

Tubular reactors are usually used for this reaction. Larger experimental reactors have for example an inner diameter of 0.05 m and a length of approximately over 3.0 m. For tests on a laboratory scale, however, commercially available differential recycle reactors (see examples) are frequently utilized.

Various sources are considered for dinitrogen monoxide. The catalytic decomposition of ammonium nitrate at 100-160° C. with manganese, copper, lead, bismuth, cobalt and nickel catalysts supplies a mixture of dinitrogen monoxide, nitrogen oxide and nitrogen dioxide, so that the gas cannot be used directly for oxidation of benzene.

Somewhat more favorable are the oxidation of ammonia with oxygen on platinum or bismuth oxide catalysts at 200-500° C., as well as the conversion of nitrogen oxide with carbon monoxide on platinum catalysts. In the first case water occurs as a by-product, in the second case carbon dioxide. The dinitrogen monoxide manufactured in this way can usually not be used directly for benzene oxidation. Likewise dinitrogen monoxide occurring during adipic acid manufacture cannot be used directly for oxidation, but must undergo a separate cleaning step. In particular, the oxygen contained in waste gas and the NOx interfere.

In recent times new processes have been developed for the production of dinitrogen monoxide, which are based in principle on ammonia and atmospheric oxygen, so that dinitrogen monoxide is produced cost-effectively. By way of example the direct manufacture of dinitrogen monoxide (N₂O) is explained comprehensively in Chem. Systems 98/99S14 (1999).

The gas containing dinitrogen monoxide can contain inert gases such as nitrogen and rare gases. But also ammonia and water vapor as well as traces of other nitrous oxides or air may be present.

Of course, microwave technology can also be applied in the manufacture of phenol and its derivatives based on benzene or the corresponding benzene derivatives for increasing selectivity and conversion. Phenol and its derivatives can be stimulated by microwaves for rotation and are thereby dissolved from the catalyst particularly easily.

### EXAMPLES

1. Manufacture of the Catalysts, Variant I

340 to 350 g of the respective starting mixture (see formulations) are stirred in a glass flask under exclusion of air with 615 g 25% tetrapropyl-ammonium-hydroxide solution in water for 1 hour. Next, this is heated carefully and evenly over the course of 5 hours to 90° C. and the alcohol thus released is expelled. The volume is then supplemented with 1150 g distilled water and the homogeneous liquid is added to an autoclave fitted with an agitator. The mixture is heated to 175° C. and left for a period of 10 days with constant stirring under its own pressure. It is then cooled and the solids are filtered off and washed several times with hot distilled water. Then the product is completely dried, heated at a heating rate of 0.5° C./min and calcined for 6 hours at 550° C. in the presence of atmospheric air.

The activity of the catalyst is determined via GC with reference to the measured conversion. The BET surface areas all lie between 400 and 600 m²/g, the average value of the pore size lies somewhere between 5 and 7 Angström, determined according to Horvath and Kawazoe (J. Chem. Eng. Jpn. 16, 1983, 470 ff.).

1.1 Catalyst, Not According to the Present Invention

Starting mixture:

| | |
|---|---|
| Tetraethylorthosilicate | 340.22 g |
| Iron (III) citrate, monohydrate | 6.13 g |
| Average pore size: | approx. 5.5 Angström |
| BET surface area: | 470 m²/g |

Analysis of the end product (% by weight):

| | |
|---|---|
| SiO₂ | 98.12% |
| Fe₂O₃ | 1.86% |

1.2 Catalyst, Not According to the Present Invention

Starting mixture:

| | |
|---|---|
| Tetraethylorthosilicate | 340.22 g |
| Iron (III) acetylacetonate | 8.22 g |
| Average pore size: | approx. 5.5 Angström |
| BET surface area: | 480 m²/g |

Analysis of the end product (% by weight):

| | |
|---|---|
| SiO₂ | 98.12% |
| Fe₂O₃ | 1.85% |

1.3 Catalyst, According to the Present Invention

Starting mixture:

| | |
|---|---|
| Tetraethylorthosilicate | 340.22 g |
| Ammonium hexacyanoferrate | 6.19 g |
| Average pore size: | approx. 5.5 Angström |
| BET surface area: | 470 m²/g |

Analysis of the end product (% by weight):

| | |
|---|---|
| SiO₂ | 98.12% |
| Fe₂O₃ | 1.87% |

1.4 Catalyst, According to the Present Invention

Starting mixture:

| | |
|---|---|
| Tetraethylorthosilicate | 340.22 g |
| Iron pentacarbonyl | 4.56 g |
| Average pore size: | approx. 5.5 Angström |
| BET surface area: | 450 m²/g |

Analysis of the end product (% by weight):

| | |
|---|---|
| SiO₂ | 98.13% |
| Fe₂O₃ | 1.87% |

1.5 Catalyst, According to the Present Invention

Starting mixture:

| | |
|---|---|
| Tetraethyltitanate | 7.94 g |
| Tetraethylorthosilicate | 334.60 g |
| Aluminum hydroxide | 0.09 g |
| Ammonium hexacyanoplatinate | 1.11 g |
| Average pore size: | approx. 6.5 Angström |
| BET surface area: | 480 m²/g |

Analysis of the end product (% by weight):

| | |
|---|---|
| TiO₂ | 2.78% |
| SiO₂ | 96.50% |
| Al₂O₃ | 0.06% |
| PtO₂ | 0.65% |

1.6 Catalyst, According to the Present Invention

Starting mixture:

| | |
|---|---|
| Tetraethylorthosilicate | 334.60 g |
| Aluminum hydroxide | 1.34 g |
| Ammonium tetracyanopalladate, trihydrate | 6.44 g |
| Average pore size: | approx. 6.0 Angström |
| BET surface area: | 470 m²/g |

Analysis of the end product (% by weight):

| | |
|---|---|
| SiO₂ | 96.50% |
| Al₂O₃ | 0.87% |
| PdO | 2.62% |

### 2. Manufacture of Phenol With Catalysts as Per 1.3 and 1.4 From Benzene and Dinitrogen Monoxide (N₂O)

A commercially available differential recycle reactor (volume 31) is used for these laboratory tests. In this connection 10 g of catalyst are fixed in the reaction chamber of the differential recycle reactor. The reaction chamber can be regulated by means of an electrical wall heating unit to reaction temperatures of 300 to 500° C. Beneath the catalyst, inside the reaction chamber, a fast rotating turbine is located which suctions the reaction mixture at high speed and recycles it to the inlet of the reactor via an external pipe. By use of this procedure diffusion limitations on the catalyst surface can be excluded. In this recycling system defined quantities of benzene, N₂O and an inert gas, such as nitrogen, can be supplied and removed continuously in any ratio. Volume flows of 500 Nml/min with a ratio of inert gas /N₂O/ benzene of 19:3:1 are usually set. Gaseous samples from this cycle are injected directly into a gas chromatograph to analyze the composition of the reaction mixture. In this manner the reactor is used as a continuously operating agitator vessel. The volume flow in the inner cycle is higher by orders of magnitude than the continuously added gas quantity. The reaction time is freely definable, with a constant rate setting in after only a few hours.

### 3. Results

(Composition of the oxidation media 100% by volume of N₂O)

| | | | | Benzene | | Activity of the |
|---|---|---|---|---|---|---|
| | Test | | Temperature | conversion | Selectivity | catalyst after |
| | number | Catalyst | (° C.) | (%) | (%) | 48 hours (%) |
| Not according to | 1 | 1.1 | 390 | 16 | 91 | approx. 74 |
| the present | | | | | | |
| invention | | | | | | |
| Not according to | 2 | 1.2 | 430 | 22 | 84 | approx. 50 |
| the present | | | | | | |
| invention | | | | | | |
| According to | 3 | 1.3 | 390 | 20 | 98 | 100 |
| the present | | | | | | |
| invention | | | | | | |
| According to | 4 | 1.4 | 430 | 27 | 94 | 100 |
| the present | | | | | | |
| invention | | | | | | |

### 4. Manufacture of the Catalysts, Variant I

450 g of the starting mixture are stirred in a glass flask under exclusion of air with 800 g 25% tetrapropylammonium hydroxide solution in water for 1 hour. Next, this is heated carefully and evenly over the course of 5 hours to 90° C. and the alcohol thus released is expelled. The volume is then supplemented with 1500 g distilled water and the homogeneous liquid is added to an autoclave fitted with an agitator. The mixture is heated to 175° C. and left for a period of 10 days with constant stirring under its own pressure. It is then cooled, the solids are filtered off and washed with hot distilled water several times. Then the product is completely dried at a heating rate of 0.5° C./min and then calcinated for 6 hours at 550° C. in the presence of atmospheric air.

The BET surface areas of the manufactured compounds are approx. 450 m²/g, the average value of the pore size is 0.55 nm. Determination is made according to Horvath and Kawazoe (J. Chem. Eng. Jpn. 16, 1983, 470 ff).

The analysis values of the end products are given in % by weight.

The activity of the catalyst is determined via GC with reference to the measured benzene conversion.

Examples for the composition of the starting mixtures: component for silicon: tetraalkylorthosilicates, for example tetraethylorthosilicate. component for quadrivalent subgroup metals: metal tetrahalogenides, metal oxohalogenides, metal tetraalkoxy compounds, for example titanium tetraethylate, zirconium isopropylate. component for aluminum: aluminum hydroxide, triisobutyl aluminum component for iron: iron acetylacetonate (not according to the present invention), iron. citrate (not according to the present invention) iron nitrate (not according to the present invention); ammoniumhexacyanoferrate (according to the present invention), iron pentacarbonyl (according to the present invention).

4.1 Catalyst, Not According to the Present Invention, Manufacture According to U.S. Pat. No. 5,110,995, Example 18

| | |
|---|---|
| Analysis of the end product (% by weight): | 99.47 SiO₂ |
| | 0.52 Fe₂O₃ |
| or mass ratio | 1.0 SiO₂ |
| | 5.3 · 10⁻³ Fe₂O₃ |
| or molar ratio | 1.0 SiO₂ |
| 2 · 10⁻³ Fe₂O₃ | |

4.2Catalyst, Not According to the Present Invention, Manufacture According to U.S. Pat. No. 5,110,995, Example 38

| | |
|---|---|
| Analysis of the end product (% by weight): | 98.0 SiO₂ |
| | 1.67 Al₂O₃ |
| | 0.31 Fe₂O₃ |
| or mass ratio | 1.0 SiO₂ |
| | 1.69 10⁻² Al₂O₃ |
| | 3.1 · 10⁻³ Fe₂O₃ |
| or molar ratio | 1.0 SiO₂ |
| | 10⁻² Al₂O₃ |
| | 1.2 · 10⁻³ Fe₂O₃ |

4.3 Catalyst, Not According to the Present Invention, Manufacture According to U.S. Pat. No. 5,110,995, Example 42

| | |
|---|---|
| Analysis of the end product (% by weigbt): | 98.26 SiO₂ |
| | 1.66 Al₂O₃ |
| | 0.07 Fe₂O₃ |
| or mass ratio | 1.0 SiO₂ |
| | 1.69 · 10⁻² Al₂O₃ |
| | 7.4 · 10⁻⁴ Fe₂O₃ |
| or molar ratio | 1.0 SiO₂ |
| | 10⁻² Al₂O₃ |

4.4 Catalyst, Not According to the Present Invention, Manufacture According to U.S. Pat. No. 5,110,995, Example 47

| | |
|---|---|
| Analysis of the end product (% by weight): | 1.42 TiO₂ |
| | 97.19 SiO₂ |
| | 1.23 Al₂O₃ |
| | 0.15 Fe₂O₃ |
| or mass ratio | 1.46 · 10⁻² TiO₂ |
| | 1.0 SiO₂ |
| | 1.27 · 10⁻² Al₂O₃ |
| | 15.4 · 10⁻⁴ Fe₂O₃ |
| or molar ratio | 1.1 · 10⁻² TiO₂ |
| | 1.0 SiO₂ |
| | 7.5 · 10⁻² Al₂O₃ |
| | 5.8 · 10⁻⁴ Fe₂O₃ |

4.5 Catalyst, Not According to the Present Invention, Manufacture According to U.S. Pat. No. 5,110,995, Example 48

| | |
|---|---|
| Analysis of the end product (% by weight): | 2.57 TiO₂ |
| | 96.9 SiO₂ |
| | 0.51 Fe₂O₃ |
| or mass ratio | 2.6 · 10⁻² TiO₂ |
| | 1.0 SiO₂ |
| | 5.3 · 10⁻³ Fe₂O₃ |
| or molar ratio | 2 · 10⁻² TiO₂ |
| | 1.0 SiO₂ |
| | 2 · 10^{-3 Fe}₂O₃ |

4.6 Catalyst as Per 4.1, but Manufactured With Corresponding Quantities of Ammonium Hexacyanoferrate (According to the Present Invention)

4.7 Catalyst as Per 4.5, but Manufactured With Corresponding quantities of Ammonium Hexacyanoferrate (According to the Present Invention)

4.8 Catalyst Not According to the Present Invention, Manufactured With Iron Acetylacetonate

| | |
|---|---|
| Analysis of the end product (% by weight): | 98.14 SiO₂ |
| | 1.85 Fe₂O₃ |
| or mass ratio | 1.0 SiO₂ |
| | 18.87 · 10⁻³ Fe₂O₃ |
| or molar ratio | 1.0 SiO₂ |
| | 7.1 · 10⁻³ Fe₂O₃ |

4.9 Catalyst Not According to the Present Invention, Manufactured With Iron Acetylacetonate

| | |
|---|---|
| Analysis of the end product (% by weight): | 2.82 TiO₂ |
| | 96.46 SiO₂ |
| | 0.07 Al₂O₃ |
| | 0.64 Fe₂O₃ |
| or mass ratio | 2.92 · 10⁻² TiO₂ |
| | 1.0 SiO₂ |
| | 7.29 · 10⁻⁴ Al₂O₃ |
| | 6.64 · 10⁻³ Fe₂O₃ |
| or molar ratio | 2.2 · 10⁻² TiO₂ |
| | 1.0 SiO₂ |
| | 4.3 · 10⁻⁴ Al₂O₃ |
| | 2.5 · 10⁻³ Fe₂O₃ |

4.10 Catalyst Not According to the Present Invention, Manufactured With Iron Citrate

| | |
|---|---|
| Analysis of the end product (% by weight): | 1.6 TiO₂ |
| | 96.5 SiO₂ |
| | 1.83 Al₂O₃ |
| | 0.024 Fe₂O₃ |
| or mass ratio | 1.65 · 10⁻² TiO₂ |
| | 1.0 SiO₂ |
| | 1.89 · 10⁻² Al₂O₃ |
| | 2.48 · 10⁻⁴ Fe₂O₃ |
| or molar ratio | 1.2 · 10⁻² TiO₂ |
| | 1.0 SiO₂ |
| | 1.1 · 10⁻² Al₂O₃ |
| | 9.3 · 10⁻⁵ Fe₂O₃ |

4.11 Catalyst as Per 4.8, Manufactured With Corresponding Quantities of Ammonium Hexacyanoferrate (According to the Present Invention)

4.12 Catalyst as Per 4.9, Manufactured With Corresponding Quantities of Ammonium Hexacyanoferrate (According to the Present Invention)

4.13 Catalyst as Per 4.10, Manufactured With Corresponding Quantities of Iron Pentacarbonyl (According to the Present Invention)

### 5. Manufacture of Phenol With Catalysts According to Examples 4.1 to 4.13 From Benzene and Dinitrogen Monoxide

The same testing order was used as described under 2). Pure N₂O was used as gas containing N₂O.

| | | | | Benzene | | Activity of |
|---|---|---|---|---|---|---|
| | Test | | Temperature | conversion | Selectivity | catalyst after |
| | number | Catalyst | (° C.) | (%) | (%) | 48 hours (%) |
| Not according to | 1 | 4.1 | 425 | 18 | 94 | approx. 80 |
| to the present | | | | | | |
| invention | | | | | | |
| not according | 2 | 4.2 | 375 | 19.5 | 96 | approx. 60 |
| to the present | | | | | | |
| invention | | | | | | |
| not according | 3 | 4.3 | 400 | 21 | 97 | approx. 55 |
| to the present | | | | | | |
| invention | | | | | | |
| not according | 4 | 4.4 | 450 | 12 | 96 | approx. 50 |
| to the present | | | | | | |
| invention | | | | | | |
| not according | 5 | 4.5 | 375 | 15 | 97 | approx. 85 |
| to the present | | | | | | |
| invention | | | | | | |
| according to | 6 | 4.6 | 425 | 29 | 97 | 100 |
| the present | | | | | | |
| invention | | | | | | |
| according to | 7 | 4.7 | 375 | 32 | 99 | 100 |
| the present | | | | | | |
| invention | | | | | | |
| not according | 8 | 4.8 | 375 | 14 | 96 | approx. 80 |
| to the present | | | | | | |
| invention | | | | | | |
| not according | 9 | 4.9 | 375 | 17 | 94 | approx. 70 |
| to the present | | | | | | |
| invention | | | | | | |
| not according | 10 | 4.10 | 375 | 22 | 93 | approx. 75 |
| to the present | | | | | | |
| invention | | | | | | |
| according to | 11 | 4.11 | 375 | 36 | 99 | 100 |
| the present | | | | | | |
| invention | | | | | | |
| according to | 12 | 4.12 | 375 | 27 | 97 | 100 |
| the present | | | | | | |
| invention | | | | | | |
| according to | 13 | 4.13 | 375 | 15 | 97 | approx. 90 |
| the present | | | | | | |
| invention | | | | | | |

1. A process for manufacturing zeolite catalysts containing subgroup metals by hydrothermal synthesis with subsequent calcination, characterized in that the subgroup metals in the form of complexes of the general formula
[metal_{z}(CO)ₐ(CN)_{b}(CNR)_{c}(X)_{d}(Y)ₑ]^{n- or n+}
with z≧1,
R=alkyl chain with 1 to 10 carbon atoms,
a, b, c, d and e=0 or a whole number, wherein a, b, c, d and e can be identical or unidentical and the sum of a, b, c, d and e is ≧1,
n=0 or is a negative or positive whole number and
X and Y represent a volatile component are introduced to the hydrothermal synthesis of the zeolite catalysts.

2. Process as claimed in claim 1, characterized in that
the subgroup metals are introduced to the hydrothermal synthesis of the zeolite catalysts in the form of pure or mixed carbonyl, cyano or isonitrile complexes.

3. Process as claimed in any one of claims 1 or 2, characterized in that
the subgroup metals are introduced to the hydrothermal synthesis of the zeolite catalysts in the form of carbonyl or cyano complexes stable in an alkaline environment.

4. Process as claimed in any one of claims 1 to 3, characterized in that
vanadium, chromium, molybdenum, tungsten, manganese, titanium, zirconium, hafnium, technetium, rhenium, iron, ruthenium, osmium, copper, cobalt, rhodium, iridium, nickel, palladium, silver, gallium, gold and/or platinum is used as subgroup metal.

5. Process as claimed in any one of claims 1 to 4, characterized in that
iron pentacarbonyl or ammoniumtetracarbonylferrate is used as carbonyl complex.

6. Process as claimed in any one of claims 1 to 4, characterized in that

| | |
|---|---|
| ammoniumtetracyanonickelate, | ammoniumtetracyanopalladate, |
| ammoniumtetracyanoplatinate, | ammoniumhexacyanoruthenate, |
| ammoniumhexacyanoplatinate, | ammoniumhexacyanocobaltate, |

ammoniumhexacyanochromate and ammoniumhexacyanoferrate is used as cyano complex.

7. Process as claimed in any one of claims 1 to 6, characterized in that
the molar ratio of SiO₂ to Al₂O₃ of the calcined zeolite catalyst is maximum 1:10⁻².

8. Process as claimed in any one of claims 1 to 7, characterized in that
the molar ratio of SiO₂ to the subgroup metal of the calcined zeolite catalyst lies between 1:10⁻⁴ to 1:3×10⁻².

9. Process as claimed-in any one of claims 1 to 8, characterized in that
the zeolite: catalyst undergoes hydrothermal treatment with water vapor and the zeolite catalyst is treated at a temperature between 300-950° C. with a gas containing 1-100 mol % water vapor.

10. Use of the zeolite catalyst containing subgroup metals, manufactured as claimed in claims 1 to 9, for oxidizing organic substrates.

11. Use of the zeolite catalyst containing subgroup metals, manufactured as claimed in claims 1 to 9, for manufacturing substituted and unsubstituted hydroxy aromatic compounds.

12. Use of the zeolite catalyst containing subgroup metals, manufactured as claimed in claims 1 to 9, for manufacturing phenol from benzene, cresol from toluene, phenol substituted with several methyl groups from the corresponding benzene derivative, trimethylphenol and trimethylhydroquinone from trimethylbenzene, nitrophenol from nitrobenzene, phenol substituted with halogen from benzene substituted with halogen or aminophenol from aminobenzene.

13. Use of the zeolite catalyst containing subgroup metals, manufactured as claimed in claims 1 to 9, for manufacturing pyrocatechine, resorcinol, hydroquinone, pyrogallol or phloroglucine.

14. Use of the zeolite catalyst containing subgroup metals, manufactured as claimed in claims 1 to 9, for manufacturing tocopherolene.

15. Use of the zeolite catalyst containing subgroup metals, manufactured as claimed in claims 1 to 9, for manufacturing propylene oxide from propene with hydrogen peroxide, or with dinitrogen monoxide.

16. Use of the zeolite catalyst containing subgroup metals, manufactured as claimed in claims 1 to 9, as catalyst for removing nitrogen.

17. Use of the zeolite catalyst containing subgroup metals, manufactured as claimed in claims 1 to 9, in fuel cells.
